(19) United States
(12) Patent Application Publication
(10) Pub. No.: US 2022/0311288 A1
(43) Pub. Date: Sep. 29, 2022

(54) STATOR TOOTH WITH STATOR-TOOTH ARC-CUTTING STRUCTURE

(71) Applicant: TECO Electric & Machinery Co., Ltd., TAIPEI CITY (TW)

(72) Inventors: Lian-Shin HUNG, TAIPEI CITY (TW); Ching-Chih HUANG, TAIPEI CITY (TW); Yu-De LI, TAIPEI CITY (TW)

(21) Appl. No.: 17/246,062

(22) Filed: Apr. 30, 2021

(30) Foreign Application Priority Data
Mar. 26, 2021 (TW) 110111062

(51) Int. Cl. H02K 1/14

(52) U.S. Cl. CPC H02K 1/146; H02K 2213/03

(57) ABSTRACT

A stator tooth includes an arc-shaped stator yoke portion and a stator tooth portion. The arc-shaped stator yoke portion extends along an arc having an axis as a center. The stator tooth portion includes a tooth body segment and two shoe-shaped structures. The tooth body segment, protruding along a centripetal axis from the arc-shaped stator yoke portion, has a first inner arc-shaped edge defined with a first center and a first radius. The centripetal axis passes through a center point of first inner arc-shaped edge, the first center and the axis. The two shoe-shaped structures extend oppositely, but symmetrically, from the tooth body segment, and each the shoe-shaped structure has a second inner arc-shaped edge and an inner-edge end point. The second inner arc-shaped edge, extending from the first inner arc-shaped edge to the inner-edge end point, has a second radius larger than the first radius.

This application claims the benefit of Taiwan Patent Application Serial No. 110111062, filed Mar. 26, 2021, the subject matter of which is incorporated herein by reference.

### BACKGROUND OF THE INVENTION

### (1) Field of the Invention

The invention relates to a stator tooth, and more particularly to a stator tooth with a stator-tooth arc-cutting structure.

### (2) Description of the Prior Art

Generally speaking, according to structural differences, motors can be roughly divided into synchronous motors, induction motors, reversible motors, stepping motors, servo motors and linear motors. Among all, with various advantages in constant speed, low starting torque, stable speed and high efficiency, the synchronous motors are widely applied to versatile fields such as automatic production equipment, refrigeration and air conditioning, and power equipment.

As described above, the synchronous motor mainly provides an alternating current to the coil of the stator, and then generates a corresponding magnetic field to rotate the rotor, in which the rotational speed of the rotor will be the same as the frequency of the alternating current. In the art, the synchronous motor having the rotor furnished with permanent magnets is called as a permanent-magnet synchronous motor. In the permanent-magnet synchronous motor, after the coil provided to the stator tooth portion is energized, a magnetic field will be induced to act against another magnetic field of the permanent magnet provided to the rotor. When the magnetic pole of the coil and the magnetic pole of the permanent magnet are corresponded to each other, the magnetic attraction force between the aforesaid two poles is the maximum. However, when the rotor continues to rotate further to stagger the two magnetic poles, then the magnetic attraction force in between would resist the rotation of the rotor, and form a cogging torque to affect the rotation of the rotor.

Refer to FIG. 1 and FIG. 2; where FIG. 1 is a schematic view of a stator of a conventional permanent magnet motor, and FIG. 2 demonstrates schematically a stator tooth of FIG. 1. As shown, the stator PA100 of he permanent magnet motor is formed by integrating a plurality of slice-shaped stator teeth PAL Each of the stator teeth PA1 includes a yoke portion PA11 and a tooth portion PA12, and the tooth portion PA12 further has an inner arc-shaped edge PA121.

Practically, the coil winding the stator tooth PA1 would be energized to generate a magnetic field, and the rotor (not shown in the figure) for providing another magnetic field is mounted inside the stator PA100 of the permanent magnet motor. In order to achieve the maximum interaction between the magnetic field generated by the coil at the stator tooth PA1 and the other magnetic field generated by the permanent magnet at the rotor, the gap between the stator PA100 and the rotor would be extremely small. However, when the pole of the coil at the stator tooth PA1 is different to that of the magnet at the rotor, a repulsive force against rotation of the rotor would be formed, and from which abnormal phenomena such as cogging torque at the rotor, total harmonic distortion of the counter electromotive force and torque ripples would be formed.

In order to improve the aforesaid cogging torque, total harmonic distortion of the counter electromotive force or torque ripples in running the permanent-magnet synchronous motor, many efforts such as oblique grooving at the stator, rotor segmentation, arc-cutting at the outer rim of the rotor or arc-cutting at the magnet are developed; in which, though the oblique grooving at the rotor or the rotor segmentation can improve the cogging torque, yet the associated manufacturing processes are much complicated, and the basic amplitude of the induced electromotive force would be lowered. Thereupon, the output power and torque would be reduced as well. Thus, the most common technical solution thereto is the arc-cutting at the magnet. The theory of this arc-cutting at the magnet is to shift horizontally the center of rotor circle by a predetermined distance to form a center of arc-cutting circle. Then, based on the center of arc-cutting circle, a circle with a radius equal to a distance from the center of arc-cutting circle to an outer rim of the rotor is drawn, and part of the magnet located beyond the circle is removed.

As described above, though the arc-cutting upon the magnet may reduce the cogging torque and extenuate the torque ripples, yet the associated process would make thinner ends of the magnet, and thus anti-demagnetization ability of the magnet would be reduced as well. Even more seriously, the consequence may cause the magnet to demagnetization, and by which normal operation of the motor might be retarded.

### SUMMARY OF THE INVENTION

In view that, while in reducing the aforesaid aforesaid cogging torque, total harmonic distortion of the counter electromotive force and torque ripples by arc-cutting the magnet, the demagnetization of the magnet caused by thinner ends thereof is inevitable, accordingly it is an object of the present invention to provide a stator tooth with a stator-tooth arc-cutting structure that can reduce the effects of the cogging torque and the torque ripples without arc-cutting the magnet.

In the present invention, the stator tooth with a stator-tooth arc-cutting structure includes an arc-shaped stator yoke portion and a stator tooth portion.

The arc-shaped stator yoke portion is extended along an arc of a circle having an axis as a center of the circle. The stator tooth portion includes a tooth body segment and two shoe-shaped structures. The tooth body segment, formed by protruding along a centripetal axis from the arc-shaped stator yoke portion as a unique piece, has a first inner arc-shaped edge defined with a first center of curvature and a first radius of curvature. The centripetal axis passes through a center point of first inner arc-shaped edge, the first center of curvature and the axis.

The two shoe-shaped structures are extended oppositely, but symmetrically with respect to the centripetal axis, from the tooth body segment, and each of the two shoe-shaped structures has a second inner arc-shaped edge and an inner-edge end point. The second inner arc-shaped edge, extending from a corresponding end of the first inner arc-shaped edge to the inner-edge end point, has a second radius of curvature larger than the first radius of curvature.

In addition, the first center of curvature is spaced from the inner-edge end point of the corresponding shoe-shaped structure by a first distance, and the first distance is larger than the first radius of curvature.

In one embodiment of the present invention, each of the two shoe-shaped structures further has a root of protrusion, the first center of curvature is spaced from the root of protrusion by a second distance, and the second distance is larger than the first distance.

In one embodiment of the present invention, the two second inner arc-shaped edges are both overlapped by a reference arc line, the reference arc line intersects the centripetal axis at a center point of the second inner arc-shaped edge, the center point of the second inner arc-shaped edge is spaced from the center point of the first inner arc-shaped edge by a concave depth, the center point of the second inner arc-shaped edge is spaced from the first center of curvature by a radial spacing, and a sum of the radial spacing and the concave depth is equal to the first radius of curvature. Preferably, the reference arc line and the arc have the same center of circle, and the radial spacing is larger than the concave depth.

In one embodiment of the present invention, the first inner arc-shaped edge further has two end points, and the second inner arc-shaped edge of the corresponding shoe-shaped structure is extended from a corresponding one of the two end points to the inner-edge end point of the corresponding shoe-shaped structure. Preferably, the two end points of the first inner arc-shaped edge forms an angle ranging from 80° to 120° with respect to the first center of curvature.

As stated, the stator tooth with the stator-tooth arc-cutting structure provided by this invention is mainly to provide the stator tooth portion with a first inner arc-shaped edge and two second inner arc-shaped edges. In addition, since the radius of curvature of the first inner arc-shaped edge is smaller than that of any of the two second inner arc-shaped edges, thus the concave arc-cutting structure can be formed at the stator tooth portion by producing the first inner arc-shaped edge in the middle of the two second inner arc-shaped edges. Thereupon, through the two second inner arc-shaped edges to keep closer to the rotor, the magnetic flux between the rotor and the stator can be maintained at a high level. Simultaneously, with the existence of the first inner arc-shaped edge, the rotational resistance caused by the magnetic forcing between poles of the the rotor and the stator can be substantially reduced, and thus the cogging torque and the torque ripples can be effectively inhibited.

All these objects are achieved by the stator tooth with a stator-tooth arc-cutting structure described below.

### BRIEF DESCRIPTION OF THE DRAWINGS

The present invention will now be specified with reference to its preferred embodiment illustrated in the drawings, in which:

FIG. 1 is a schematic view of a conventional stator of a permanent magnet motor;

FIG. 2 demonstrates schematically the stator tooth of FIG. 1;

FIG. 3 is a schematic view of an embodiment of the stator tooth with a stator-tooth arc-cutting structure in accordance with the present invention;

FIG. 4 is a schematic view of a stator composed of a plurality of the stator teeth of FIG. 3;

FIG. 5 is another view of FIG. 3 with different labels; and

FIG. 6 illustrates schematically variations of operation torque with respect to time for a permanent magnet motor having the stator teeth with individual stator-tooth arc-cutting structures in accordance with the present invention and another permanent magnet motor having the conventional stator teeth.

### DESCRIPTION OF THE PREFERRED EMBODIMENT

The invention disclosed herein is directed to a stator tooth with a stator-tooth arc-cutting structure. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

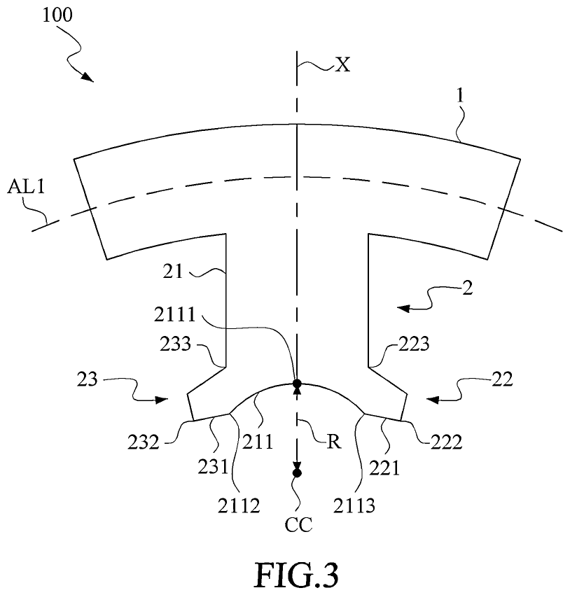

Referring to FIG. 3, an embodiment of the stator tooth with a stator-tooth arc-cutting structure in accordance with the present invention is schematically shown. In this embodiment, the stator tooth with a stator-tooth arc-cutting structure 100 includes an arc-shaped stator yoke portion 1 and a stator tooth portion 2.

The arc-shaped stator yoke portion 1 is extended along an arc AL1. The stator tooth portion 2 includes a tooth body segment 21 and two shoe-shaped structures 22 and 23. The tooth body segment 21 is formed by protruding along a centripetal axis X from the arc-shaped stator yoke portion 1 as a unique piece, and has a first inner arc-shaped edge 211 defined with a first center of curvature CC and a first radius of curvature R. The centripetal axis X is to penetrate through a center point of first inner arc-shaped edge 2111 and the first center of curvature CC of the first inner arc-shaped edge 211. In addition, the first inner arc-shaped edge 211 further has thereof two opposite end points 2112, 2113 and a center point 2111 disposed at a center of the two end points 2112 and 2113.

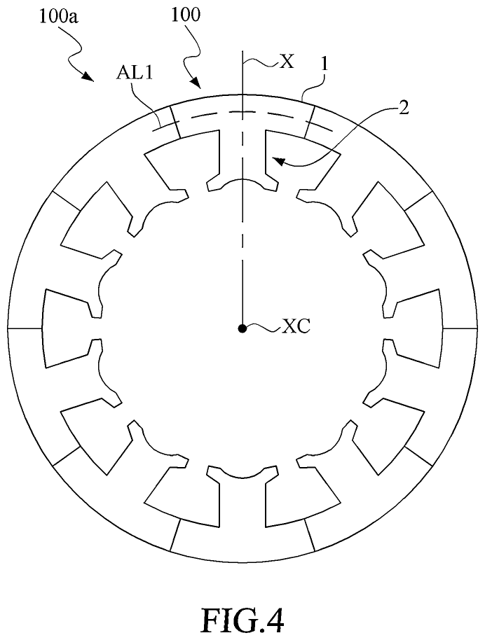

Referring to FIG. 4, a stator composed of a plurality of the stator teeth of FIG. 3 is schematically shown. As shown in FIG. 3 and FIG. 4, a plurality of the stator teeth 100 with individual stator-tooth arc-cutting structures are assembled side by side to form a stator 100a. The aforesaid centripetal axis X penetrates through an axis XC of the stator 100a; i.e., the arc AL1 is a part of a circle having the axis XC as the center of circle.

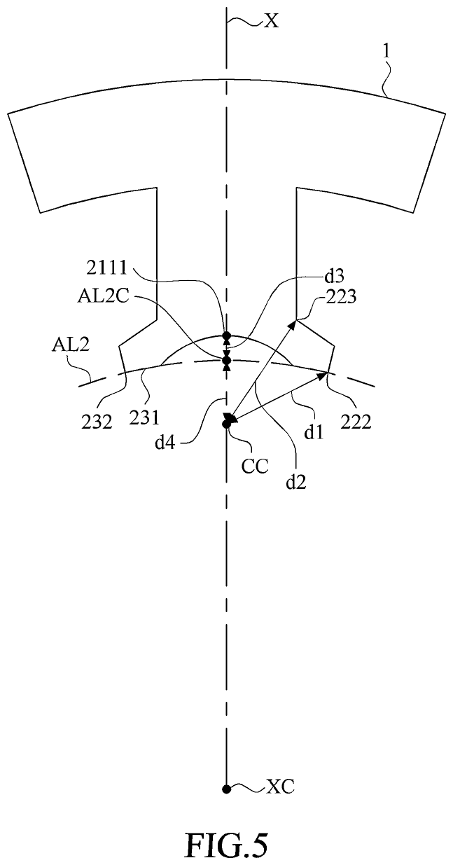

Referring to FIG. 5, another view of FIG. 3 with different labels is provided for a concise explanation purpose. As shown in FIG. 3 and FIG. 5, the two shoe-shaped structures 22, 23 are extended oppositely, but symmetrically with respect to the centripetal axis X, from the same tooth body segment 21. In other words, the two shoe-shaped structures 22 and 23 are two sides of mirror-symmetry with respect to the centripetal axis X.

By having the shoe-shaped structure 22 as an example, the shoe-shaped structure 22 has a second inner arc-shaped edge 221, an inner-edge end point 222 and a root of protrusion 223. The second inner arc-shaped edge 221 is a portion of an arc AL2 extended from the end point 2113 of the first inner arc-shaped edge 211 to the inner-edge end point 222, and the root of protrusion 223 is disposed at the junction of the shoe-shaped structure 22 and the tooth body segment 21. Similarly, the shoe-shaped structure 23 has a second inner arc-shaped edge 231, an inner-edge end point 232 and a root of protrusion 233. The second inner arc-shaped edge 231 is another portion of the arc AL2 extended from the end point 2112 of the first inner arc-shaped edge 211 to the inner-edge end point 232, and the root of protrusion 2323 is disposed at the junction of the shoe-shaped structure 23 and the tooth body segment 21.

In addition, though each of the second inner arc-shaped edges 221 and 231 of the corresponding shoe-shaped structures 22 and 23 is defined by having the axis XC as the center of curvature, yet, in some other embodiments, each of the second inner arc-shaped edges 221 and 231 of the corresponding shoe-shaped structures 22 and 23 may be defined by another center of curvature (not shown in the figure).

As shown in FIG. 3 and FIG. 5, the two second inner arc-shaped edges 221, 231 are both overlapped by the same reference arc line (i.e., the arc AL2), and the reference arc line AL2 is intersected with the centripetal axis X at a center point AL2C of the two second inner arc-shaped edges 221 and 231. The center point AL2C of the two second inner arc-shaped edges 221 and 231 is spaced from another center point 2111 of the first inner arc-shaped edge 211 by a concave depth d3, and from the first center of curvature CC by a radial spacing d4. The sum of the radial spacing d4 and the concave depth d3 is equal to the first radius of curvature R. In addition, in this embodiment, the reference arc line AL2 and the arc AL1 have the same center of circle at XC.

As described above, the first center of curvature CC is spaced from each of the two inner-edge end points 222 and 232 of the corresponding shoe-shaped structures 22 and 23 by a first distance d1 (only one labeled in the figure) larger than the first radius of curvature R. In addition, the first center of curvature CC is spaced from each of the two roots of protrusion 223 and 233 of the corresponding shoe-shaped structures 22 and 23 by a second distance d2 (only one labeled in the figure) larger than the first distance d1.

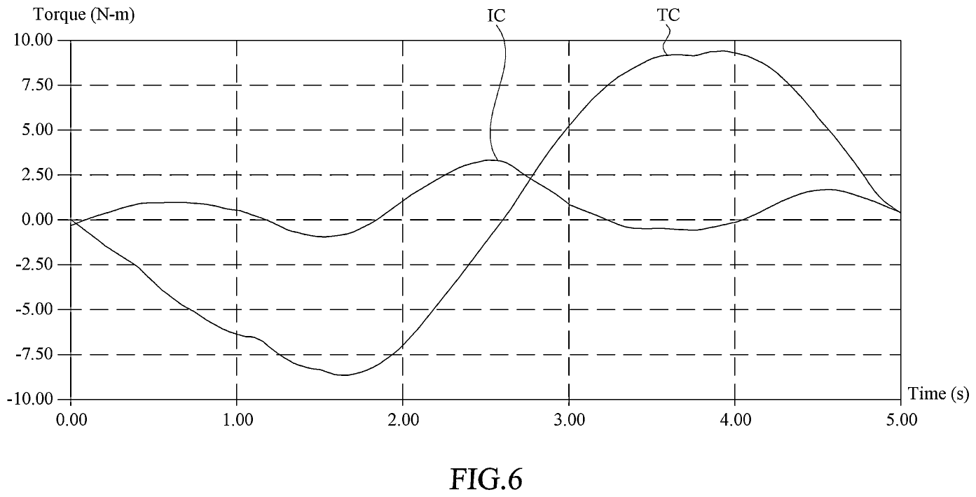

Referring to FIG. 6, variations of operation torque with respect to time for a permanent magnet motor having the stator teeth with individual stator-tooth arc-cutting structures in accordance with the present invention and another permanent magnet motor having the conventional stator teeth are schematically provided.

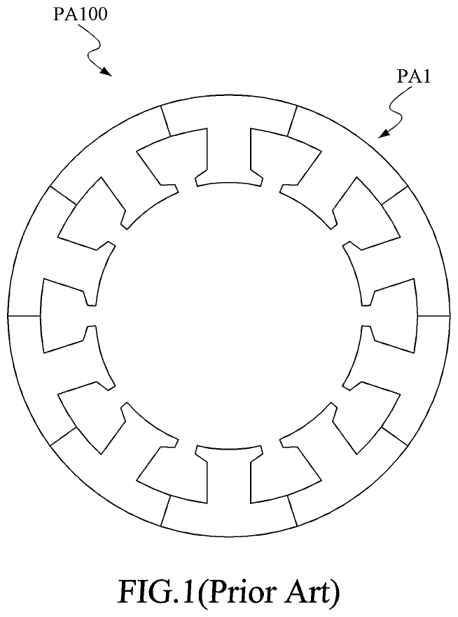

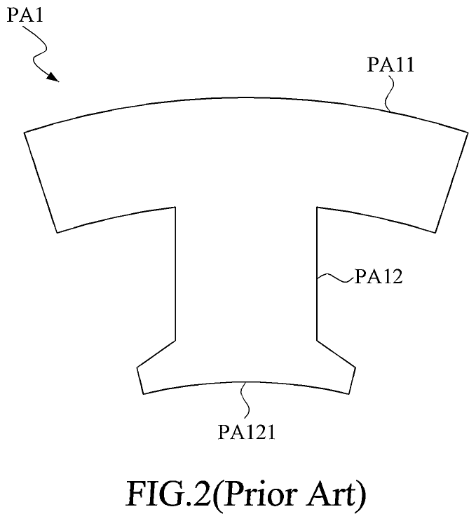

As shown from FIG. 1 to FIG. 6, the conventional stator PA100 is formed by integrating the conventional stator teeth PA1, and then the conventional stator PA100 is used to produce a conventional permanent magnet motor (not shown in the figure). A variation of operation torque for this conventional permanent magnet motor is illustrated by Curve TC in FIG. 6. On the other hand, the stator 100a is formed by integrating the stator teeth 100 with individual stator-tooth arc-cutting structures provided by this invention, and then this stator 100a is used to produce another permanent magnet motor (not shown in the figure) in accordance with the present invention. A variation of operation torque for this permanent magnet motor of the present invention is illustrated by Curve IC in FIG. 6.

By comparing Curve TC with Curve IC, it is found that the operation torques of the permanent magnet motor having the stator 100a furnished with the stator teeth 100 with individual stator-tooth arc-cutting structures provided by the present invention are fluctuated in smaller amplitudes than that of the conventional permanent magnet motor having the stator PA100 furnished with the conventional stator teeth PAL Logically, it can be concluded as well that the effects of the cogging torque and the torque ripples at the permanent magnet motor having the stator 100a furnished with the stator teeth 100 with individual stator-tooth arc-cutting structures provided by the present invention can be substantially reduced.

In summary, the stator tooth with the stator-tooth arc-cutting structure provided by this invention is mainly to provide the stator tooth portion with a first inner arc-shaped edge and two second inner arc-shaped edges. In addition, since the radius of curvature of the first inner arc-shaped edge is smaller than that of any of the two second inner arc-shaped edges, thus the concave arc-cutting structure can be formed at the stator tooth portion by producing the first inner arc-shaped edge in the middle of the two second inner arc-shaped edges. Thereupon, through the two second inner arc-shaped edges to keep closer to the rotor, the magnetic flux between the rotor and the stator can be maintained at a high level. Simultaneously, with the existence of the first inner arc-shaped edge, the rotational resistance caused by the magnetic forcing between poles of the rotor and the stator can be substantially reduced, and thus the cogging torque and the torque ripples can be effectively inhibited.

While the present invention has been particularly shown and described with reference to a preferred embodiment, it will be understood by those skilled in the art that various changes in form and detail may be without departing from the spirit and scope of the present invention.

What is claimed is:

1. A stator tooth with a stator-tooth arc-cutting structure, comprising:
an arc-shaped stator yoke portion, extended along an arc of a circle having an axis as a center of the circle; and
a stator tooth portion, including:
a tooth body segment, formed by protruding along a centripetal axis from the arc-shaped stator yoke portion as a unique piece, having a first inner arc-shaped edge defined with a first center of curvature and a first radius of curvature, the centripetal axis passing through a center point of first inner arc-shaped edge, the first center of curvature and the axis; and
two shoe-shaped structures, extended oppositely and symmetrically with respect to the centripetal axis from the tooth body segment, each of the two shoe-shaped structures having a second inner arc-shaped edge and an inner-edge end point, the second inner arc-shaped edge extending from a corresponding end of the first inner arc-shaped edge to the inner-edge end point, the second inner arc-shaped edge having a second radius of curvature larger than the first radius of curvature;
wherein the first center of curvature is spaced from the inner-edge end point of the corresponding shoe-shaped structure by a first distance, and the first distance is larger than the first radius of curvature.

2. The stator tooth with a stator-tooth arc-cutting structure of claim 1, wherein each of the two shoe-shaped structures further has a root of protrusion, the first center of curvature is spaced from the root of protrusion by a second distance, and the second distance is larger than the first distance.

3. The stator tooth with a stator-tooth arc-cutting structure of claim 1, wherein the two second inner arc-shaped edges are both overlapped by a reference arc line, the reference arc line intersects the centripetal axis at a center point of the second inner arc-shaped edge, the center point of the second inner arc-shaped edge is spaced from the center point of the first inner arc-shaped edge by a concave depth, the center point of the second inner arc-shaped edge is spaced from the first center of curvature by a radial spacing, and a sum of the radial spacing and the concave depth is equal to the first radius of curvature.

4. The stator tooth with a stator-tooth arc-cutting structure of claim 3, wherein the reference arc line and the arc have the same center of circle.

5. The stator tooth with a stator-tooth arc-cutting structure of claim 3, wherein the radial spacing is larger than the concave depth.

6. The stator tooth with a stator-tooth arc-cutting structure of claim 1, wherein the first inner arc-shaped edge further has two end points, and the second inner arc-shaped edge of the corresponding shoe-shaped structure is extended from a corresponding one of the two end points to the inner-edge end point of the corresponding shoe-shaped structure.

7. The stator tooth with a stator-tooth arc-cutting structure of claim 6, wherein the two end points of the first inner arc-shaped edge forms an angle ranged from 80° to 120° with respect to the first center of curvature.
